(19) United States
(12) Patent Application Publication
(10) Pub. No.: US 2024/0072496 A1
(43) Pub. Date: Feb. 29, 2024

(54) POWER SYSTEM WITH AUTOMATIC DISCONNECT

(71) Applicant: Mission Critical Electronics, LLC, Costa Mesa, CA (US)

(72) Inventors: Thomas H. Nugent, JR., Port Jefferson Station, NY (US); Paul Lamattina, Miller Place, NY (US); Philip Sgroi, Shirley, NY (US); Dale Tompkins, Plymouth, WI (US); Elton Muñoz, Bay Shore, NY (US)

(21) Appl. No.: 18/452,323

(22) Filed: Aug. 18, 2023

Related U.S. Application Data
(60) Provisional application No. 63/386,230, filed on Dec. 6, 2022.
(60) Provisional application No. 63/373,288, filed on Aug. 23, 2022.

(51) Int. Cl. H01R 13/713; B60L 53/16; B60L 53/66; H01R 43/26

(52) U.S. Cl. CPC H01R 13/7132; B60L 53/16; B60L 53/66; H01R 43/26; H01R 2201/26

(57) ABSTRACT

Automatic ejection assemblies for an electric vehicle plug and methods for controlling the same. An automatic ejection assembly includes a mounting assembly for mounting the automatic ejection assembly to an electric vehicle plug and a first automatic ejection mechanism configured to cause the electric vehicle plug to eject from an electric vehicle. A method includes detecting a disconnect trig per by an automatic ejection control system, where the disconnect trigger indicated that an automatic-eject plug should be ejected from an electric vehicle. The method includes, in response to detecting the disconnect trigger, controlling an ejection assembly connected to the automatic-eject plug to cause the automatic-eject plug to eject from the electric vehicle.

### CROSS-REFERENCE TO RELATED APPLICATION

This application claims the benefit of the filing dates of U.S. Provisional Patent Application 63/373,288, filed Aug. 23, 2022, and U.S. Provisional Patent Application 63/386,230, filed Dec. 6, 2022, both of which are hereby incorporated by reference. This application includes some subject matter in common with, but is otherwise unrelated to, U.S. patent application Ser. No. 17/449,215, filed Sep. 28, 2021, and U.S. Provisional Patent Application 63/113,716, filed Nov. 13, 2020, both of which are hereby incorporated by reference.

### TECHNICAL FIELD

The present disclosure is directed, in general, to apparatuses, methods, and devices for safely delivering electricity to a vehicle, trailer, or other object. Specific embodiments are directed to electric-power delivery systems with automatic disconnection features.

### BACKGROUND OF THE DISCLOSURE

Electric vehicles, trailers, and other objects (collectively, “vehicles”) require occasional electric power connections for temporary power or charging purposes. If the power connection is not properly disconnected under certain circumstances, such as when charging is complete or the vehicle is being moved, physical or electrical damage can result. Improved systems are desirable.

### SUMMARY OF THE DISCLOSURE

Various disclosed embodiments include an electric delivery apparatus configured to automatically physically disconnect from an electric vehicle, such as a consumer or commercial automobile, upon a trigger event such as a charging-complete signal, a brake pedal activation, an engine or motor activation, a gearshift activation, an air-pressure detection, or otherwise. An “electric vehicle” is intended to include hybrid vehicles and other vehicles to which a power delivery plug may be attached for battery charging or for temporary electrification of onboard equipment or accessories.

In various embodiments, the electric delivery apparatus is a charging or power delivery system including a charging device that includes a power delivery plug (also “auto-eject plug”), where the power delivery plug includes a mechanical disconnect apparatus that physically disconnects the power delivery plug from power inlet or a charging port of the electric vehicle.

In various embodiments, the electric delivery apparatus is a power delivery plug configured to be connected to a charging or power delivery system, where the power delivery plug includes a mechanical disconnect apparatus that physically disconnects the power delivery plug from a power inlet or charging port of the electric vehicle.

Various embodiments include a disconnection apparatus configured to be attached to a power delivery plug that is connected to a charging or power delivery system, where the disconnection apparatus includes a controller and a mechanical disconnect apparatus that physically disconnects the power delivery plug from a power inlet or charging port of the electric vehicle.

In various embodiments, the mechanical disconnect apparatus can be, for example, an electrically-powered or air-powered solenoid, actuator, lever, or other device.

Various embodiments include a method for controlling an automatic-ejection plug connected to an electric vehicle. The method includes detecting a disconnect trigger by an automatic ejection control system, the disconnect trigger indicating that an automatic-eject plug should be ejected from an electric vehicle. The method includes, in response to detecting the disconnect trigger, controlling an ejection assembly connected to the automatic-eject plug to cause the automatic-eject plug to eject from the electric vehicle. In some embodiments, the method also includes, before detecting the disconnect trigger, detecting that the automatic-eject plug is connected to the electric vehicle and controlling charging to the electric vehicle through the automatic-eject plug. In some embodiments, the method also includes retracting the automatic-eject plug from the immediate proximity of the electric vehicle.

In various embodiments, the automatic-eject plug has a connection that conforms to one of the Electric Vehicle Supply Equipment (EVSE), Combined Charging Standard/Type 1 (CCS1), Combined Charging Standard/Type 2 (CCS2), North American Charging Standard (NAGS), International Electrotechnical Commission (TEC) 62196 Type 1, IEC Type 2. TEC Type 3, and TS-0023666 standard connections. In various embodiments, controlling the ejection assembly to cause the automatic-eject plug to eject from the electric vehicle includes activating an air actuated cylinder. In various embodiments, controlling the ejection assembly to cause the automatic-eject plug to eject from the electric vehicle includes activating one or more linear actuators. In various embodiments, controlling the ejection assembly to cause the automatic-eject plug to eject from the electric vehicle includes activating one or more motors. In various embodiments, controlling the ejection assembly to cause the automatic-eject plug to eject from the electric vehicle includes activating one or more solenoids. In various embodiments, detecting a disconnect trigger includes detecting a signal indicating that charging has completed. In various embodiments, detecting a disconnect trigger includes detecting a signal indicating that a brake pedal has been pressed on the electric vehicle. In various embodiments, detecting a disconnect trigger includes detecting a remote-control disconnect signal.

Other embodiments include automatic ejection assembly of an electric vehicle plug. The automatic ejection control assembly is configured to detect a disconnect trigger, the disconnect trigger indicating that the automatic-eject plug should be ejected from an electric vehicle, and in response to detecting the disconnect trigger, cause the electric vehicle plug to eject from the electric vehicle. The automatic ejection assembly attached, integrally or removably, to the electric vehicle plug. The automatic ejection control system can have any of the features described herein, or any combination of them.

Other embodiments include an automatic-eject plug having a connection end for connecting to an electric vehicle and an automatic ejection mechanism that causes the automatic-eject plug to eject from the electric vehicle. The automatic-eject plug can have any of the features described herein, or any combination of them.

Another embodiment includes an automatic ejection assembly having a mounting assembly for mounting the automatic ejection assembly to an electric vehicle plug and a first automatic ejection mechanism configured to cause the electric vehicle plug to eject from an electric vehicle, Various embodiments also include a second automatic-ejection mechanism configured to activate a release mechanism of the electric vehicle plug. In various embodiments, the first automatic-ejection mechanism and/or the second automatic-ejection mechanism includes at least one of an air actuated cylinder, a linear actuator, a motor, or a solenoid.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely, Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates an example of a push solenoid embodiment in accordance with the disclosure;

FIG. 2 illustrates an example of a gear motor embodiment in accordance with the disclosure;

FIG. 3 illustrates an example of a linear actuator embodiment in accordance with the disclosure;

FIG. 4 illustrates an example of a servo motor embodiment in accordance with the disclosure;

FIG. 5 illustrates an example of a BEV automatic ejection control system embodiment in accordance with the disclosure;

FIG. 6 illustrates an example of an automatic ejection charging system embodiment in accordance with the disclosure;

FIG. 7 illustrates an example of an automatic ejection system embodiment in accordance with the disclosure;

FIG. 8 illustrates an example of an electrical schematic for an automatic ejection system embodiment for a BEV implementation in accordance with the disclosure;

FIG. 9 illustrates an example of an electrical schematic for an automatic ejection system embodiment for an EVSE implementation in accordance with the disclosure;

FIG. 10 illustrates an example of a control board embodiment in accordance with the disclosure;

FIG. 11 illustrates an example of a control board embodiment in accordance with the disclosure;

FIG. 12 illustrates an example of an electrical schematic for an automatic ejection system embodiment in accordance with the disclosure;

FIG. 13 illustrates an example of a CCS1 automatic ejection system embodiment with spring assist in accordance with the disclosure;

FIG. 14 illustrates an example of a CCS2 automatic ejection system embodiment in accordance with the disclosure;

FIG. 15 illustrates an example of an automatic smart winch embodiment in accordance with the disclosure;

FIG. 16 illustrates a front view of an example of an automatic-eject plug embodiment in accordance with the disclosure;

FIG. 17 illustrates a first isometric view of an example of an automatic-eject plug embodiment in accordance with the disclosure;

FIG. 18 illustrates a second isometric view of an example of an automatic-eject plug embodiment in accordance with the disclosure;

FIG. 19 illustrates a view of an example of a release servo for an automatic-eject plug embodiment in accordance with the disclosure;

FIG. 20 illustrates a view of an example of a spring-assist assembly automatic-eject plug embodiment in accordance with the disclosure;

FIG. 21 illustrates a side view of an example of an automatic-eject plug with a Type 2 connector in accordance with disclosed embodiments;

FIG. 22 illustrates an isometric view of an example of an automatic-eject plug in accordance with disclosed embodiments with a Type 2 connector;

FIG. 23 illustrates an isometric view of an example of an automatic-eject plug in accordance with disclosed embodiments with a Type 2 connector;

FIG. 24 illustrates a side view of an example of an automatic-eject plug in accordance with disclosed embodiments with a CCS2 connector;

FIG. 25 illustrates an isometric view of an example of an automatic-eject plug in accordance with disclosed embodiments with a CCS2 connector;

FIG. 26 illustrates an isometric view of an example of an automatic-eject plug in accordance with disclosed embodiments with a CCS2 connector;

FIG. 27 illustrates an example of a CCS2 automatic ejection system embodiment with a linear actuator in accordance with the disclosure;

FIG. 28 illustrates an example of an electrical schematic for an automatic ejection system embodiment in accordance with the disclosure;

FIG. 29 illustrates an example of a state sequence for one implementation of an automatic ejection control system in accordance with disclosed embodiments; and

FIG. 30 depicts a flowchart of a process in accordance with disclosed embodiments.

### DETAILED DESCRIPTION

The figures referenced below and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Various embodiments can be used, in particular, with battery electric vehicles (BEV) using Electric Vehicle Supply Equipment (EVSE), Combined Charging Standard/Type 1 (CCS), Combined Charging Standard/Type 2 (CCS2) and/or North American Charging Standard (NACS) connections, and those implementations are described herein, but those of skill in the art will recognize that the scope of the inventions are not limited to those implementations. For example, disclosed embodiments can be used with International Electrotechnical Commission (TEC) 62196 Type 1, Type 2, Type 3, and TS-0023666 connections and other vehicle electrical connections. “Electric vehicle” or “EV,” as used herein, is intended to include any BEV, hybrid vehicle, trailer, or other vehicle that uses any type of removable plug for charging or power delivery, so that disclosed embodiments are intended to apply to any charging apparatus that uses an automatically-ejecting plug as described herein.

Disclosed embodiments include an automatic charge cord disconnect device designed to work with CCS1 and CCS2 for BEV combination cord plugs being used on hybrid and all current electric vehicles. In particular, various embodiments include a plug assembly (or “ejection assembly”) that can be attached to an existing EV plug, permanently or removably, to provide auto-eject features as described herein. The plug assembly can include an actuating device such as an air actuated cylinder or an electric servo motor. For CCS1 and NACS use cases, the actuating device can engage the plug handle release button, which will then disengage the plug retaining mechanism. For CCS2 use cases, an automatic or “smart” winch and/or dynamic spring-loaded or linear actuator powered collar, will assist with appropriate tension and/or retraction of the CCS2 plug handle. In either case, the plug handle will disengage from power delivery inlet mounted on the vehicle or apparatus. In various embodiments, the CCS1, CCS2, or NACS inlet's safety lock mechanism can be monitored and unlocked, if necessary, before disengaging the plug from the inlet. A cable management system can be used to apply constant cable tension. The self-tensioning mechanism allows the cable to naturally untether from the attached vehicle or apparatus. Note that disclosed embodiments, in general, can monitor the safety lock state, whether locked or unlocked, but various embodiments consider the case in which the lock state cannot be determined. In these cases, disclosed embodiments can use a timer or other delay mechanism to implement a short delay before ejecting the plug from the inlet.

In various embodiments, an automated or “smart” winch can provide appropriate tension at the time of disengagement. A static or dynamic (power actuated) spring-loaded or linear actuator powered assist collar may be attached to the plug handle to overcome the friction encountered during disengagement.

Self-tensioning or smart winch mechanisms will allow the cable to naturally untether from the attached vehicle or apparatus. A manual release lever or device may be attached to the handle to facilitate manual disconnection of the plug from the vehicle inlet.

Various embodiments include a CCS1 or CCS2 combo or NACS plug, which can include a latching and unlatching button(s), that is modified to automatically disconnect from the inlet mounted on the vehicle or apparatus. This modification can be accomplished by modifying the plug itself or by attaching a plug assembly as disclosed herein to unlock and eject the plug.

In various embodiments, a spring-loaded collar may be attached at the face of the plug to assist in disengagement from the inlet. The springs will be compressed when the plug is inserted into the inlet. Upon ejection or manual release, the springs decompress to provide force to overcome friction encountered during disengagement of the plug from the inlet. In various embodiments, a release mechanism, such as a lever or push-button, may be activated to trigger the safety lock on the EV to release the plug from the inlet, allowing the springs to force the plug to eject from the inlet. A plug assembly as disclosed herein can activate the release mechanism.

A controller can be used to monitor the inlet's safety lock mechanism to determine if it is in a locked or unlocked state. If an eject sequence is to be performed, the charging process (or power to the vehicle) will be interrupted. The inlet will then be unlocked to facilitate disengagement of the plug.

The mechanical disconnect apparatus plug assembly can include, for example, either an air actuated cylinder, electric servo motor, or linear actuator. In either case, the mechanical disconnect apparatus is configured to integrate with, and mount to (permanently or removably), in various embodiments, an existing EV plug such as a CCS1 or CCS2 plug with or without a handle release button.

Additional system components can include PCB assemblies with embedded microcontrollers, mounted on the plug/EVSE side and/or the vehicle/BEV or apparatus side (also referred to as the power inlet or charging port side).

Additionally, a cable management tensioner, whether custom or off-the-shelf, can be mounted to the wall or other structure and used to apply constant cable tension. The cable tension is needed to quickly manage and pull the cable/plug away from the vehicle or apparatus and also keep cable/plug off the floor.

Alternately, in some embodiments, an automated winch system may be implemented in lieu of the tensioner described above. The winch will provide retracting tension when required. It can utilize a clutch mechanism or similar to release the cable to allow for insertion of the plug in the inlet.

In some embodiments, a CCS1, CCS2, NACS, or other EV plug is manually connected to the vehicle or apparatus when battery charging or other source of power is required. At this point the vehicle or apparatus is now connected and tethered to a charging combo cable with either CCS1, CCS2, NACS, or other EV plug.

Currently, when it is time to detach the CCS1, CCS2, NACS, or other EV plug, the driver must manually release the CCS1, CCS2, NACS, or other EV plug handle release button and pull the plug away from the inlet. Finally, the plug must be stored in its holder/holster when not in use.

Disclosed embodiments, instead, provide an automatic disconnection mechanism that can be integral to or attached to an EV plug.

In various embodiments, when it is time to detach the CCS1, CCS2, NACS, or other EV plug, the driver enters the vehicle or apparatus and applies the brake pedal. Applying the brake pedal initiates the automatic unlocking of the inlet and release of the tethered plug, which is then automatically ejected from the EV as disclosed herein. The action of depressing the brake pedal causes the brake light to illuminate. In disclosed embodiments, a controller on the vehicle is used to sense the brake signal.

Once the brake signal is detected, the on-board controller sends necessary data to the plug side controller, mounted on the plug assembly or inside the EVSE or power supply enclosure. This data can be sent via existing tethered cable or wirelessly.

Additionally, an on-board Controller Area Network Bus (CANBUS), PowerLine Communications (PLC) or Local Interconnect Network (IAN) can be used over the Control Pilot (CP) line as depicted in DIN70121, ISO 15118, IEC 61581 and/or SAE J3068 to send necessary data to the plug side controller, whiCh can be read by the plug side controller and used to perform automatic disconnection as described herein as well as other functions.

In various embodiments, on the inlet side, components including the inlet side controller are used to receive and begin the auto eject process. Charging is stopped and the inlet safety lock is moved to an unlocked state.

On the plug/EVSE side, a plug side controller and mechanical disconnect mechanism can be used to receive data, control signals, and/or commands and complete the auto eject process.

The plug/EVSE side receiving controller receives data to enable the detach process. For CCS1 and NACS, for example, the controller can apply power to an electric servo or air cylinder that engages or depresses the plug handle release button. For CCS2 connections, there is no plug handle release button, but the plug has already been unlocked at the inlet side.

The plug/EVSE side controller converts received data and applies power to the electric servo or air cylinder.

The electric servo or air cylinder engages the CCS1 or NACS plug handle release button to release the handle attachment mechanism. Similarly, a smart winch, in combination with a dynamic spring-loaded collar, can be used with CCS2 type plug handles to release and retract the plug from the inlet. Now that the CCS1, CCS2, or NACS attachment mechanism is disengaged the cable and plug are free to detach from the vehicle or apparatus.

In CCS1 and NACS connections, for example, a cable management tensioner, typically mounted to the wall, with constant tension, quickly springs into action to pull the disengaged cable/plug from the vehicle or apparatus. The cable/plug are then naturally retracted away from the vehicle or apparatus and off the floor or ground.

For CCS2 connections, for example, the handle can be detached by a smart winch which supplies retraction force to the charging cable. The cable/plug are retracted from the vehicle or apparatus and suspended off the floor or ground.

The CCS1, CCS2, or MACS plug auto eject process is now complete and ready to repeat the charging process.

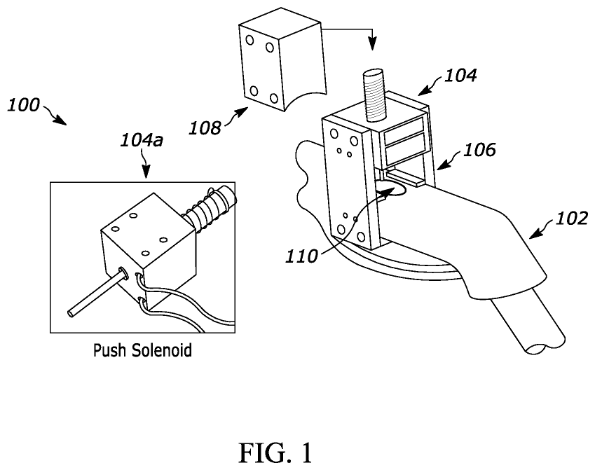

FIG. 1 illustrates an example of a push solenoid embodiment in accordance with the disclosure. FIG. 1 illustrates an automatic-disconnect plug assembly 100 that can be integrated with or attached to an EV plug 102, which can be implemented using any of the EV plug types described herein. A push-solenoid actuator 104 is mounted to EV plug 102 by mounting bracket 106. Push-solenoid actuator 104a shows push-solenoid actuator 104 before being mounted on EV plug 102. Waterproof cover 108 can be mounted on mounting bracket 106 to cover actuator 104.

As is illustrated here, a push-solenoid actuator 104 is configured and located to depress release button 110 of EV plug 102 when push-solenoid actuator 104 is activated.

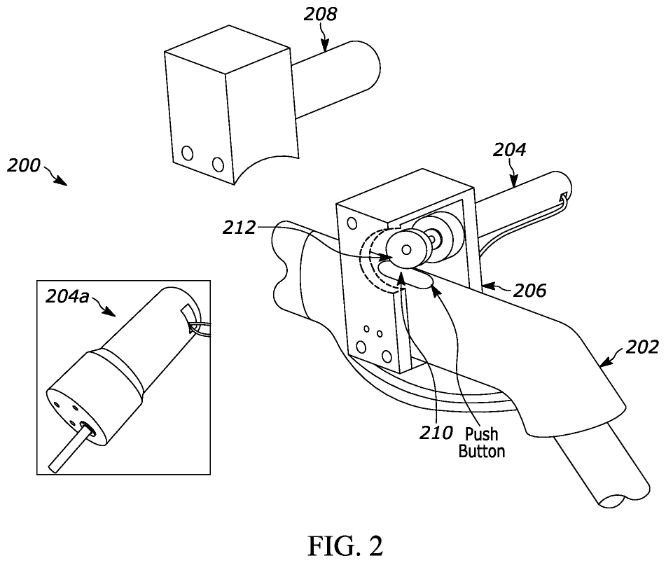

FIG. 2 illustrates an example of a gear motor embodiment in accordance with the disclosure. FIG. 2 illustrates an automatic-disconnect plug assembly 200 that can be integrated with or attached to an EV plug 202, which can be implemented using any of the EV plug types described herein. A gear motor 204 with cam 212 is mounted to EV plug 202 by mounting bracket 206. Gear motor 204a shows gear motor 204 before being mounted on EV plug 202. Waterproof cover 208 can be mounted on mounting bracket 206 to cover gear motor 204 and cam 212.

As is illustrated here, gear motor 204 with cam 212 is configured and located so that cam 212 depresses release button 210 of EV plug 202 when gear motor 204 is activated.

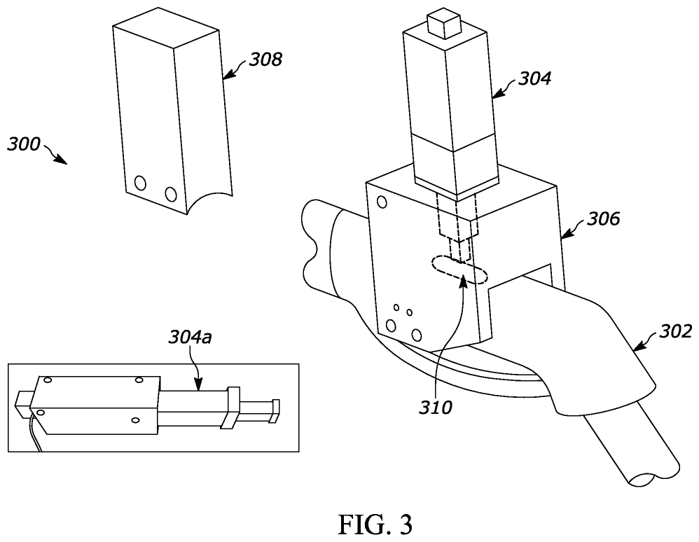

FIG. 3 illustrates an example of a linear actuator embodiment in accordance with the disclosure. FIG. 3 illustrates an automatic-disconnect plug assembly 300 that includes an EV plug 302, which can be implemented using any of the EV plug types described herein, among others. A linear actuator 304 is mounted to EV plug 302 by mounting bracket 306. Linear actuator 304a shows linear actuator 304 before being mounted on EV plug 302. Waterproof cover 308 can be mounted on mounting bracket 306 to cover a portion of linear actuator 304.

As is illustrated here, linear actuator 304 is configured and located to depress release button 310 of EV plug 302 when linear actuator 304 is activated.

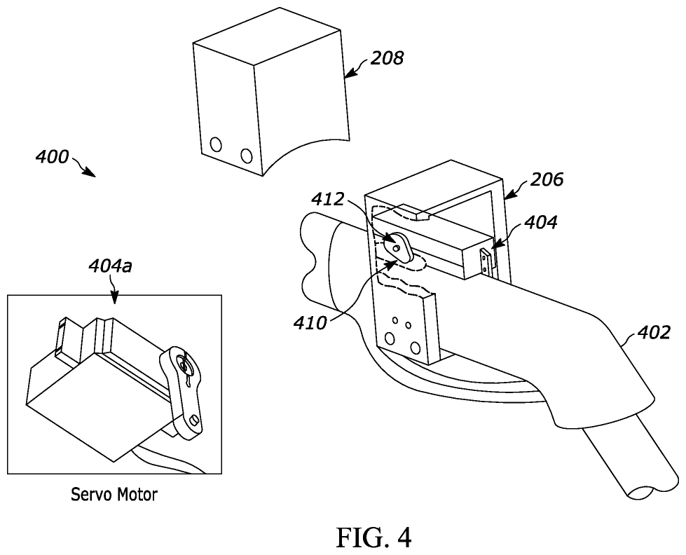

FIG. 4 illustrates an example of a servo motor embodiment in accordance with the disclosure. FIG. 4 illustrates an automatic-disconnect plug assembly 400 that includes an EV plug 402, which can be implemented using any of the EV plug types described herein. A servo motor 404 with cam 412 is mounted to EV plug 402 by mounting bracket 406. Servo motor 404a shows servo motor 404 before being mounted on EV plug 402. Waterproof cover 408 can be mounted on mounting bracket 406 to cover servo motor 404 and cam 412.

As is illustrated here, servo motor 404 with cam 412 is configured and located so that cam 412 depresses release button 410 of EV plug 402 when servo motor 404 is activated.

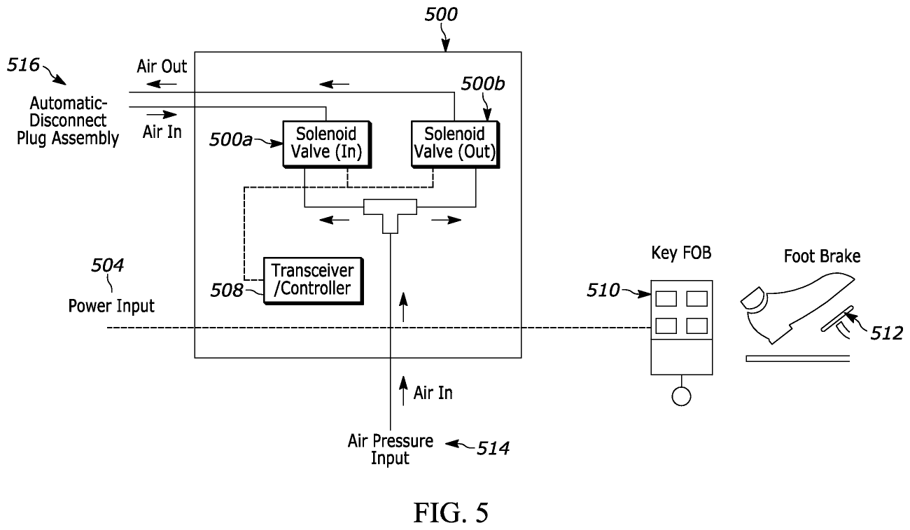

FIG. 5 illustrates an example of an EV automatic ejection control system embodiment in accordance with the disclosure. This example of EV automatic ejection control system 500 is intended to be implemented in an electric vehicle. Automatic ejection control system 500, in this example, includes a transceiver/controller 508 connected to receive a power input 504. Transceiver/controller 508 is configured to communicate, wired or wirelessly, with system components and other devices, such as wireless key fob 510 and/or brake sensor 512. Automatic ejection control system 500 is connected to receive pressurized air (or other gas) at an air pressure input 514. Transceiver/controller 508 is configured to control one or more solenoid valves 300a/500b to control the flow of pressurized air to an automatic-disconnect plug assembly 516 to cause automatic-disconnect plug assembly 516 to activate and eject itself from the electric vehicle.

In use, in some examples, when automatic ejection control system 500 detects certain triggers, which can include activation of key fob 510, activation of brake sensor 512, determining that charging is complete, or others, transceiver/controller 508 opens one or more solenoid valves 500a/500b to deliver pressurized air to an automatic-disconnect plug assembly 516 to cause the automatic-disconnect plug assembly 516 to activate and eject itself from the electric vehicle.

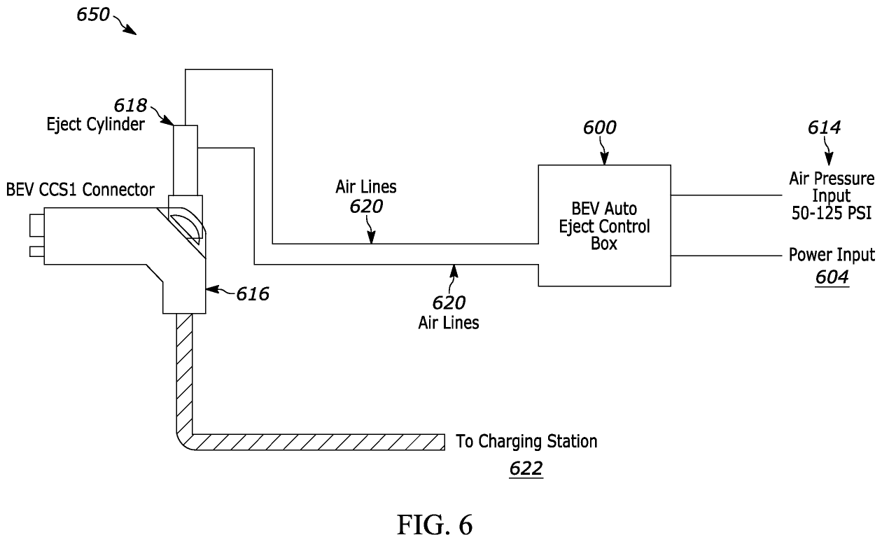

FIG. 6 illustrates an example of an automatic ejection charging system embodiment in accordance with the disclosure. In this example, an automatic ejection charging system 650 includes an automatic ejection control system 600 (such as automatic ejection control system 500) connected to automatically eject automatic-disconnect plug assembly 616. Automatic-disconnect plug assembly 616 is connected electrically to charging station 622 and receives pressurized air (or other gas) via air lines 620 from automatic ejection control system 600. Eject cylinder 618 is used to eject automatic-disconnect plug assembly 616 from an electric vehicle using the pressurized air. Automatic ejection control system 600 is connected to receive the pressurized air 614, such as at a pressure of 50-125 psi, and is also connected to a power input 604.

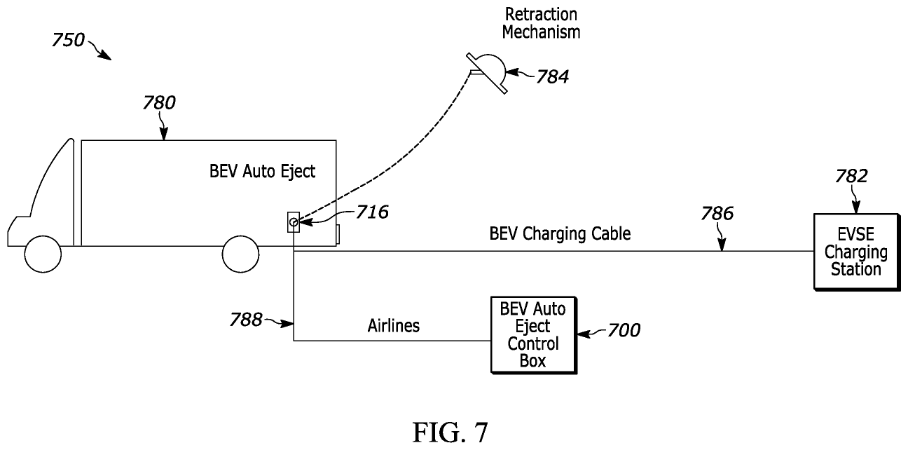

FIG. 7 illustrates an example of an automatic ejection system embodiment 750 in accordance with the disclosure. In this example, an electric vehicle 780 is connected to an automatic-disconnect plug assembly 716 (which is attached to or integral with the EV plug), which is plugged into the charging/power port of electric vehicle 780. Automatic-disconnect plug assembly 716 is connected via a charging cable to a charging station 782, such as an Electric Vehicle Supply Equipment (EVSE) charging station. Automatic-disconnect plug assembly 716 is connected via pressurized air lines (or other gas) to an automatic ejection control system 700, such as automatic ejection control system 500. Automatic ejection control system 700 can automatically eject automatic-disconnect plug assembly 716 from the charging/power port of electric vehicle 780 as described herein. When automatic-disconnect plug assembly 716 is ejected from the charging/power port of electric vehicle 780, a retraction mechanism 784 can automatically retract the automatic-disconnect plug assembly 716, and its charging cable and pressurized air lines, away from electric vehicle 780.

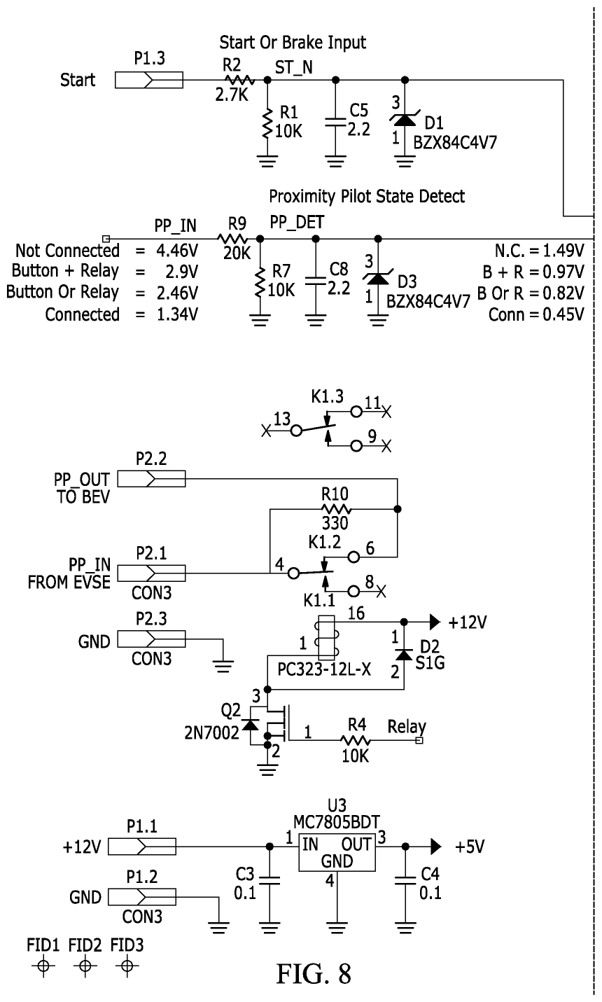

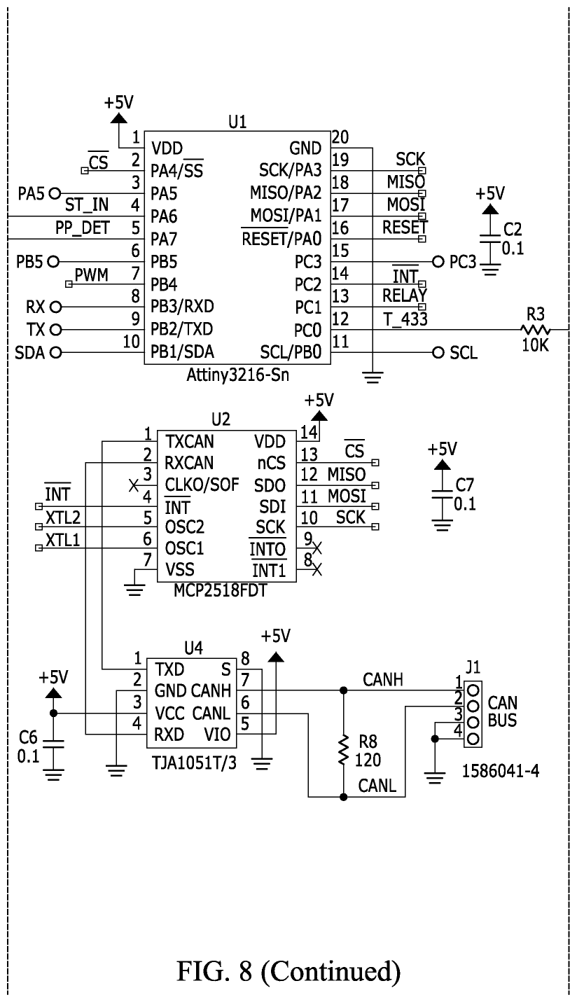

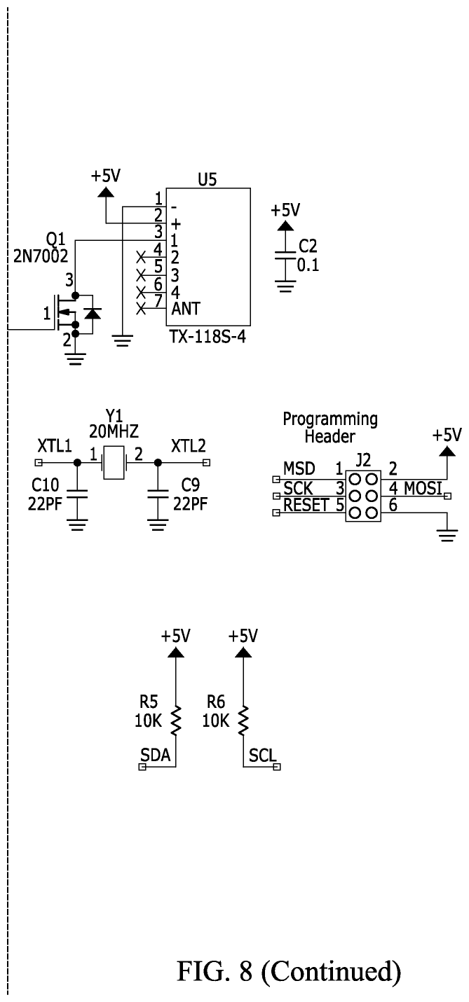

FIG. 8 illustrates an example of an electrical schematic for an automatic ejection system embodiment for an EV implementation in accordance with the disclosure,

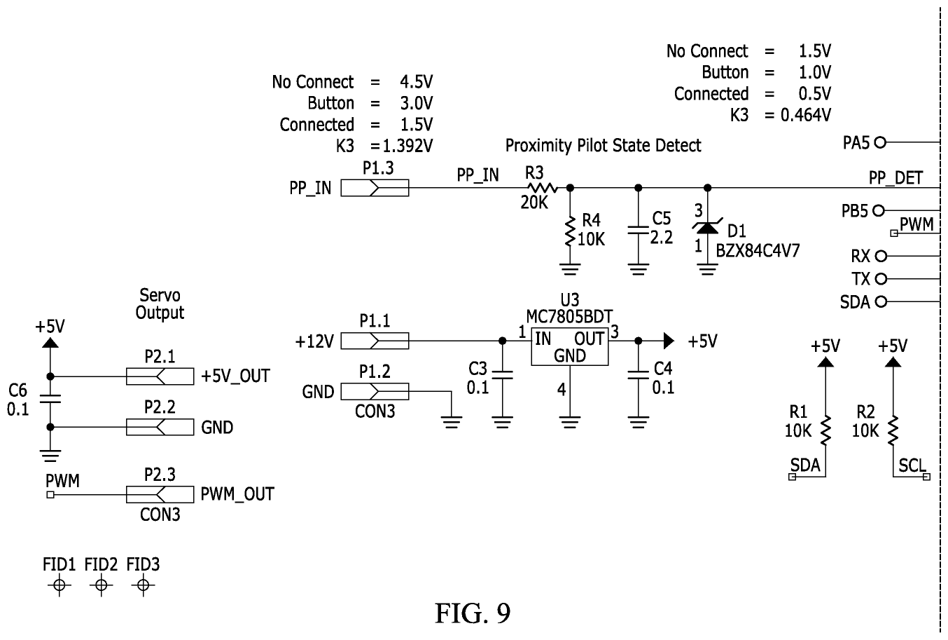

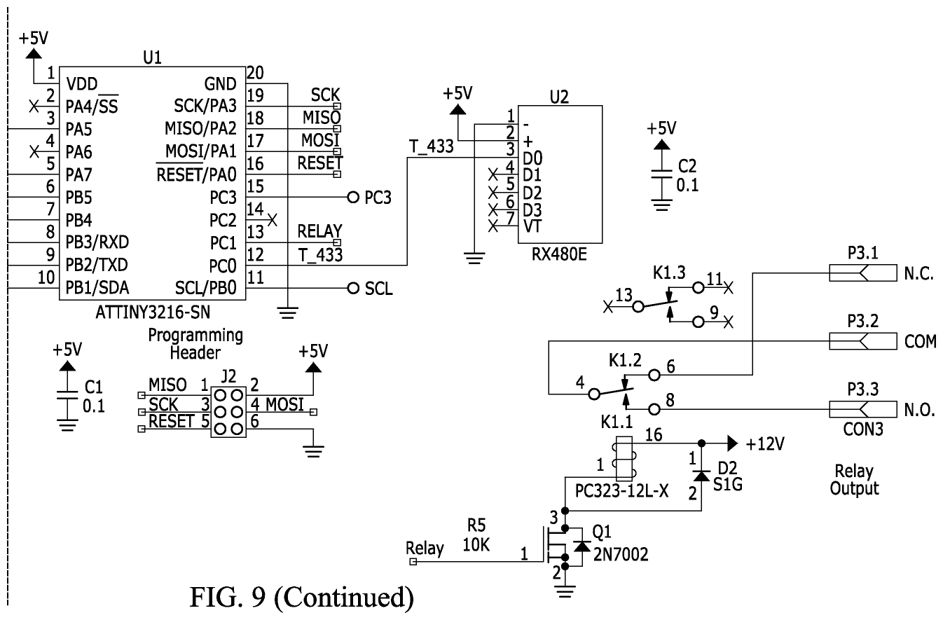

FIG. 9 illustrates an example of an electrical schematic for an automatic ejection system embodiment for an EVSE implementation in accordance with the disclosure.

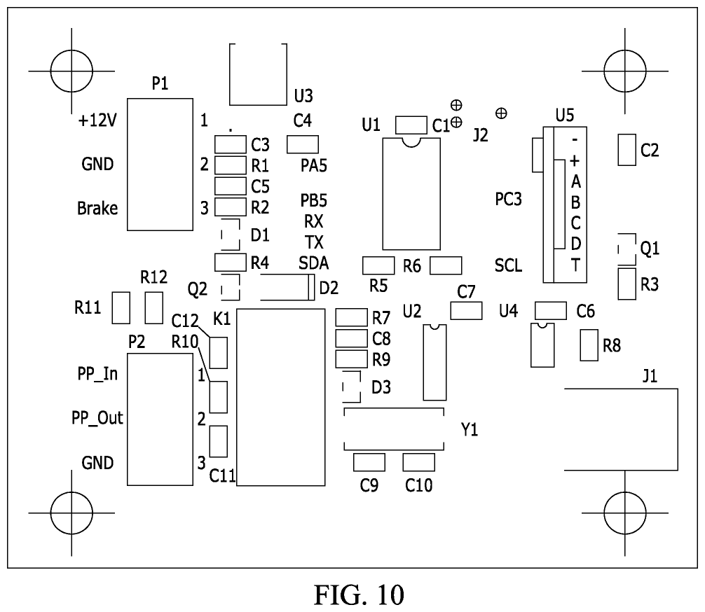

FIG. 10 illustrates an example of a control board embodiment in accordance with the disclosure.

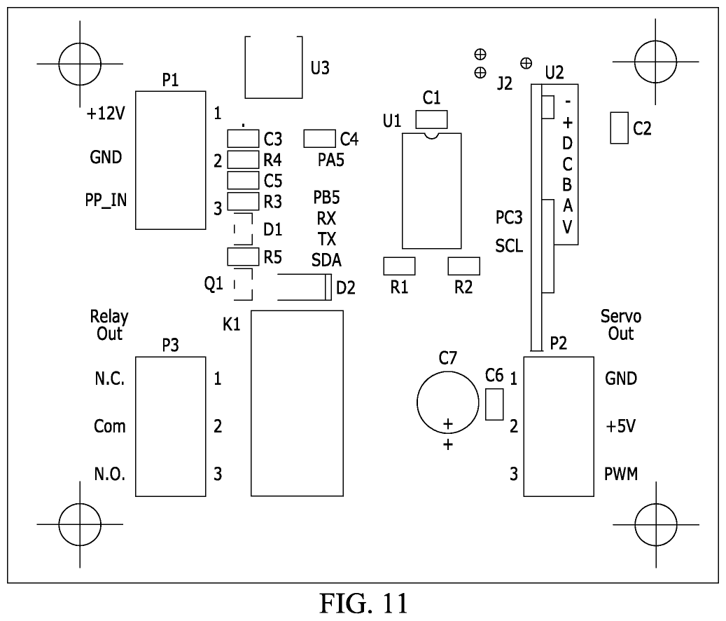

FIG. 11 illustrates an example of a control board embodiment in accordance with the disclosure.

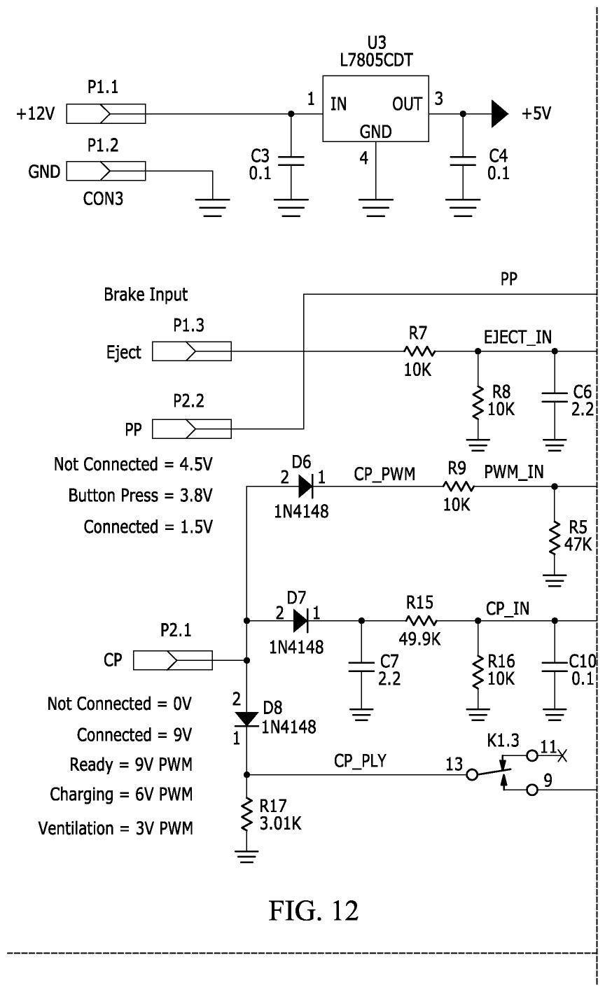

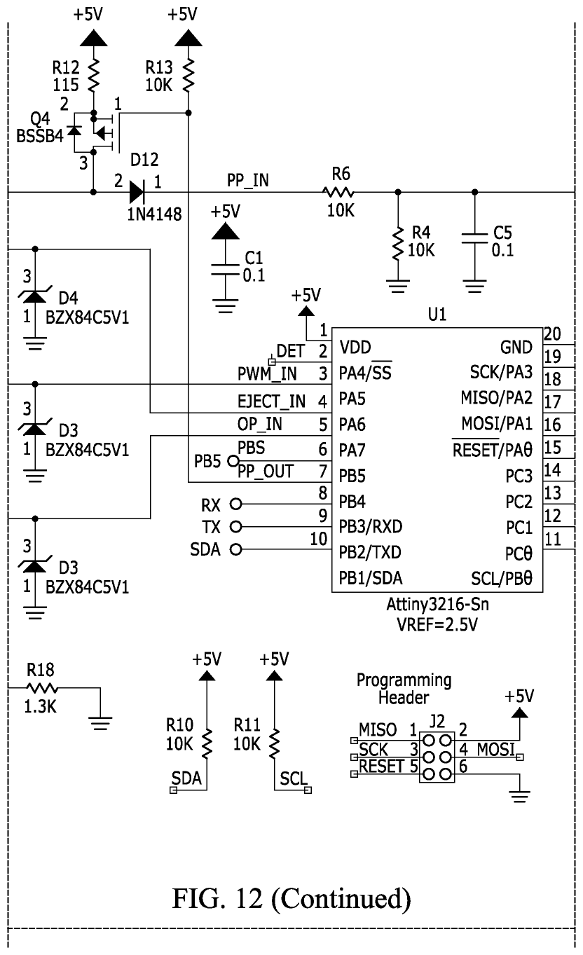

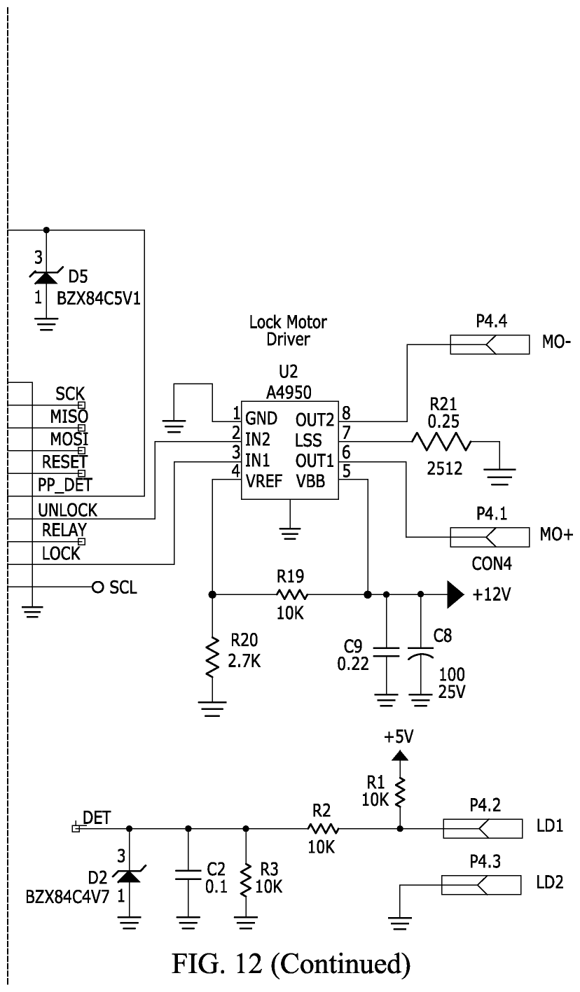

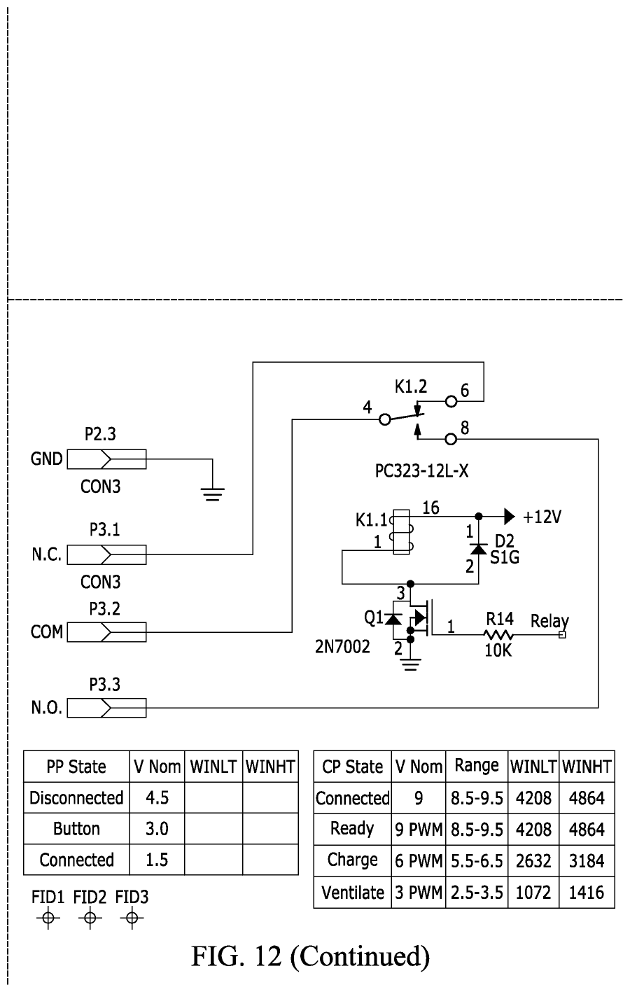

FIG. 12 illustrates an example of an electrical schematic for an automatic ejection system embodiment in accordance with the disclosure.

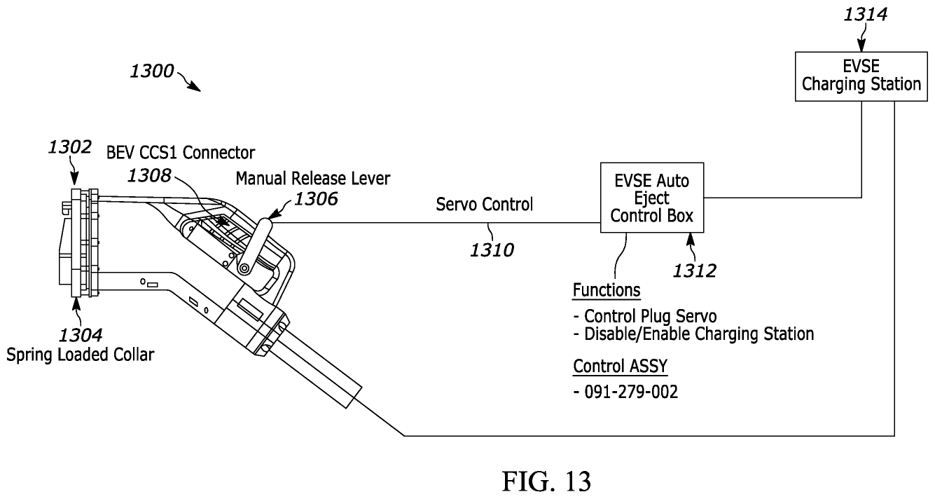

FIG. 13 illustrates an example of a CCS1 automatic ejection system embodiment with spring assist in accordance with the disclosure. In the example of FIG. 13, automatic ejection system 1300 includes an EV plug 1302 that uses a CCS1 connector. EV plug 1302 has an attached or integral plug assembly including a spring loaded collar 1304 to aid in disconnection of EV plug 1302 from an electric vehicle, a manual release lever 1306, and a servo motor 1308 configured to operate manual release lever 1306.

Servo motor 1308 is connected to a servo control line 1310 from automatic ejection control system 1312 (such as described herein). Charging station 1314 is connected to provide power to automatic ejection control system 1312 and to EV plug 1302. Automatic ejection control system 1312 can control the servo motor 1308 and can enable/disable the charging station 1314.

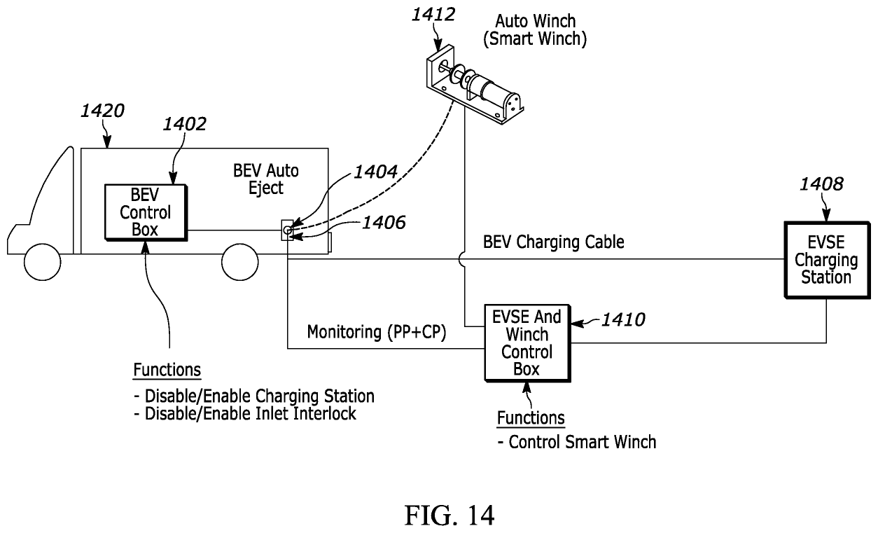

FIG. 14 illustrates an example of a CCS2 automatic ejection system embodiment in accordance with the disclosure. In this example an electric vehicle 1420 includes a charging controller 1402 and a charging receptacle/port 1404 into which EV plug 1406 is inserted.

Charging controller 1402 is capable and configured to enable and disable a charging station 1408 by communicating through EV plug 1406 and automatic ejection control system 1410 (such as described herein). Charging controller 1402 is also capable of enabling and disabling the “inlet interlock” (also called a “safely lock”) of charging receptacle/port 1404 to release the EV plug 1406. The inlet interlock can be unlocked to allow the EV plug 1406 to be inserted into or removed from charging receptacle/port 1404, and the inlet interlock can be locked to prevent the BEV plug 1406 from being inserted into or removed from charging receptacle/port 1404. Automatic ejection control system 1410 is configured to operate as described herein, and in addition can control smart winch 1412 to automatically retract EV plug 1406 and its charging/control cable(s) when EV plug 1406 is ejected from charging receptacle/port 1404.

FIG. 15 illustrates an example of an automatic “smart” winch 1502 embodiment in accordance with the disclosure.

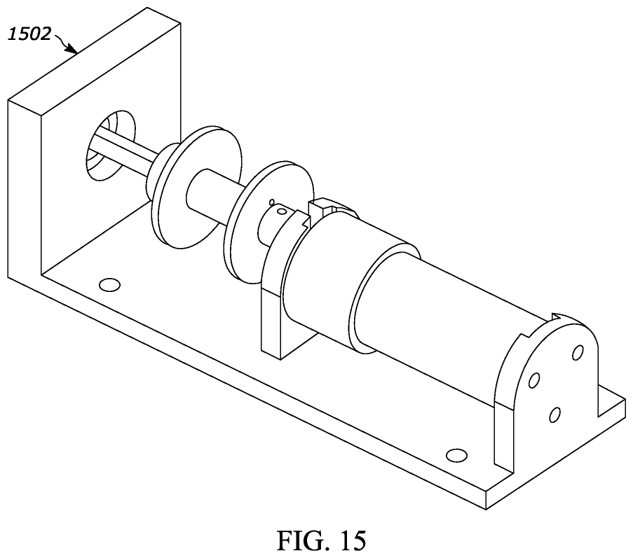

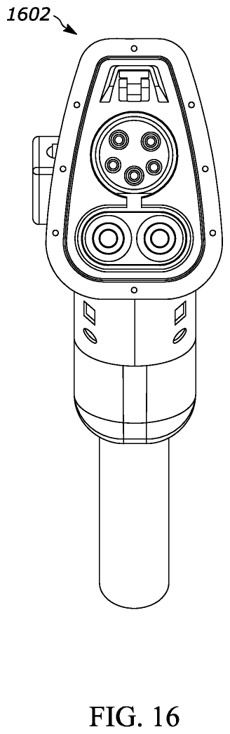

FIG. 16 illustrates a front view of an example of automatic-eject plug 1602 embodiment in accordance with the disclosure.

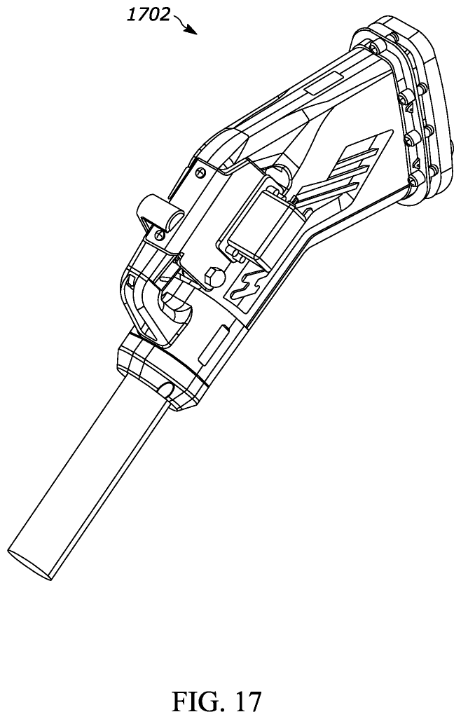

FIG. 17 illustrates a first isometric view of an example of automatic-eject plug 1702 embodiment in accordance with the disclosure.

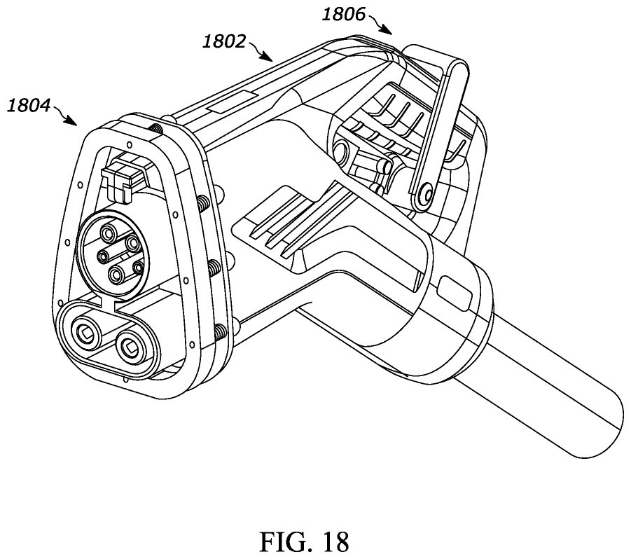

FIG. 18 illustrates a second isometric view of an example of automatic-eject plug 1802 embodiment in accordance with the disclosure. Note in particular the plug assembly components in accordance with disclosed embodiments, such as the attached spring-assist assembly 1804 and the release servo assembly 1806 that depresses the plug handle release button.

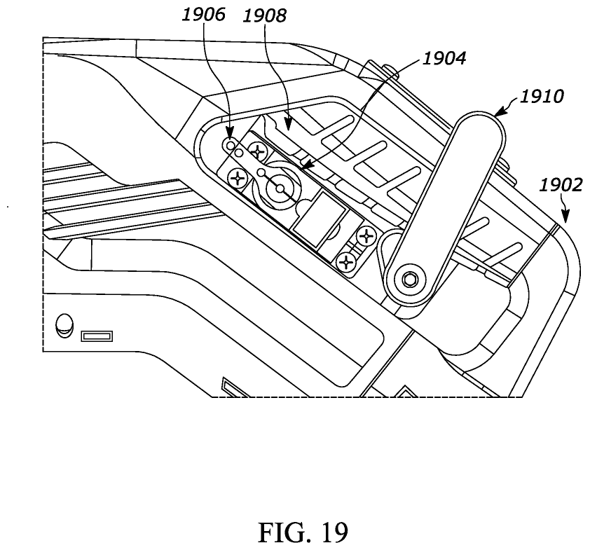

FIG. 19 illustrates a view of an example of an automatic-eject plug 1902 embodiment in accordance with the disclosure, with a plug assembly that includes release servo 1904 and connected lever 1906 that depresses the plug handle release button 1908. Various embodiments can include a manual release lever 1910 to activate the plug handle release button 1908.

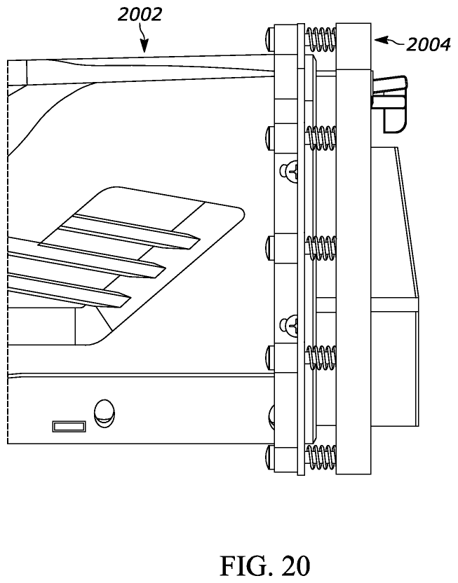

FIG. 20 illustrates a view of an example of a spring-assist assembly 2004 for an automatic-eject plug embodiment 2004 in accordance with the disclosure. Note that, in this example, spring-assist assembly 2004 is removably attached to the EV plug using screws, though any other suitable attachment means can be used.

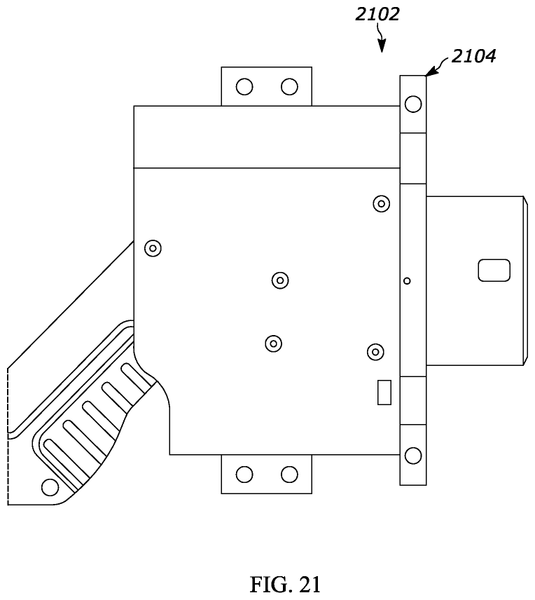

FIG. 21 illustrates a side view of an example am automatic-eject plug 2102 in accordance with disclosed embodiments with a Type 2 connector. In this example, automatic-eject collar 2104 is retracted for insertion of the automatic-eject plug 2102 into an electric vehicle.

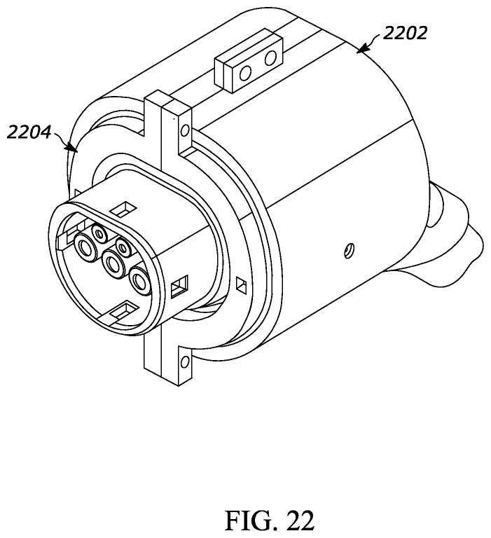

FIG. 22 illustrates an isometric view of an example of an automatic-eject plug 2202 in accordance with disclosed embodiments with a Type 2 connector. In this example, automatic-eject collar 2204 is retracted for insertion of the automatic-eject plug 2202 into an electric vehicle.

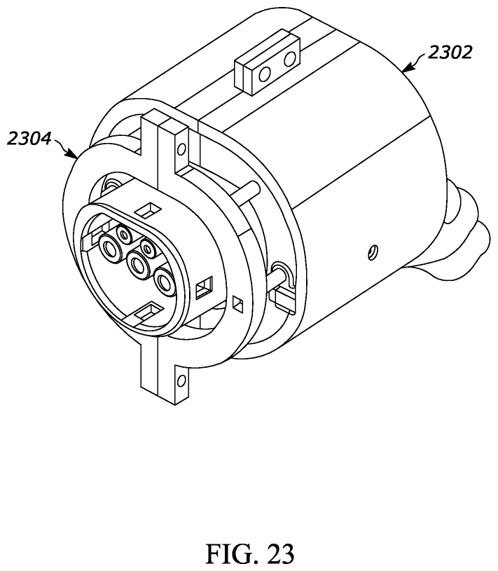

FIG. 23 illustrates an isometric view of an example of an automatic-eject plug 2302 in accordance with disclosed embodiments with a Type 2 connector. In this example, automatic-eject collar 2304 is extended as it would be to eject the automatic-eject plug 2302 from an electric vehicle.

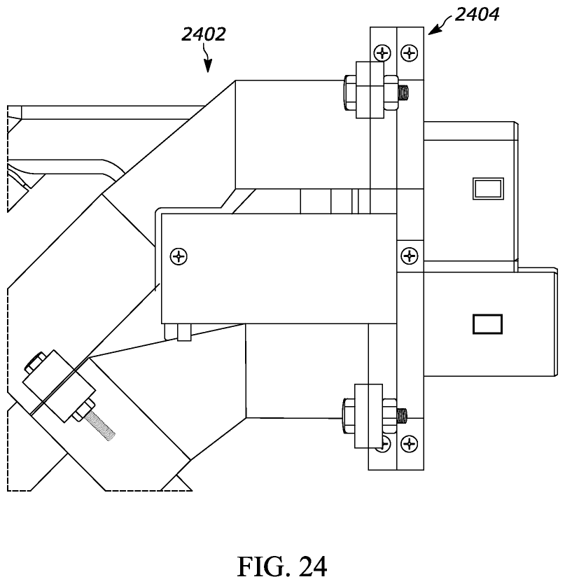

FIG. 24 illustrates a side view of an example of an automatic-eject plug 2402 in accordance with disclosed embodiments with a CCS2 connector. In this example, automatic-eject collar 2404 is retracted for insertion of the automatic-eject plug 2402 into an electric vehicle.

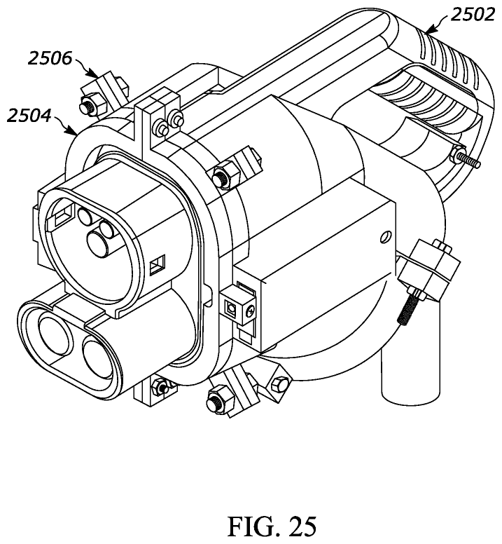

FIG. 25 illustrates an isometric view of an example of an automatic-eject plug 2502 in accordance with disclosed embodiments with a CCS2 connector. In this example, automatic-eject collar 2504 is retracted for insertion of the automatic-eject plug 2502 into an electric vehicle. Note that automatic-eject collar 2504 is removably attached to the plug 2502, such as by using fastener bolts 2506, though other fasteners can be used.

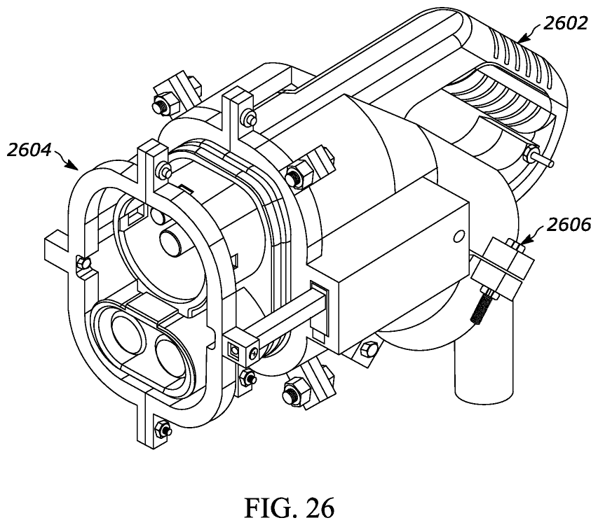

FIG. 26 illustrates an isometric view of an example of an automatic-eject plug 2602 in accordance with disclosed embodiments with a CCS2 connector. In this example, automatic-eject collar 2604 is extended as it would be to eject the automatic-eject plug 2602 from an electric vehicle. Note that automatic-eject collar 2604 and other components of the auto-eject plug assembly are removably attached to the plug 2602, such as by using fastener bolts 2606, though other fasteners can be used.

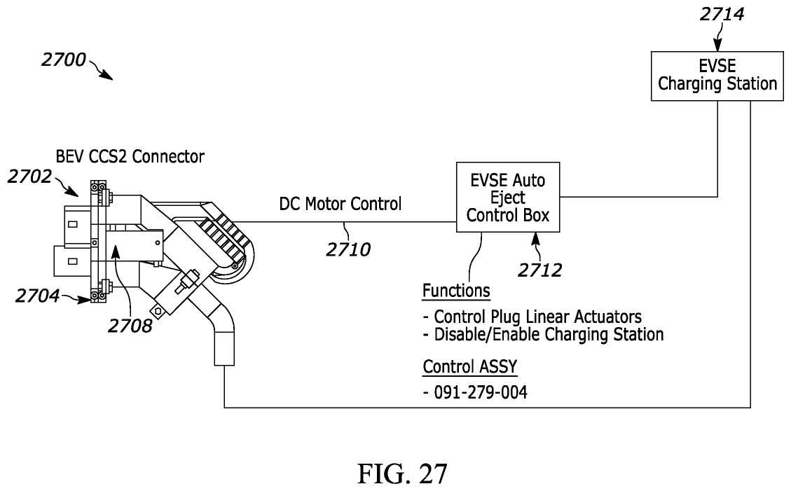

FIG. 27 illustrates an example of a CCS2 automatic ejection system embodiment with a linear actuator in accordance with the disclosure. In the example of FIG. 27, automatic ejection system 2700 includes an EV plug 2702 that uses a BEV CCS2 connector. EV plug 2702 has a linear-actuated collar 2704 to aid in disconnection from an electric vehicle that is driven by linear actuator assembly 2708.

Linear actuator assembly 2708 is connected to a DC motor control line 2710 from automatic ejection control system 2712 (such as described herein). Charging station 2714 is connected to provide power to automatic ejection control system 2712 and to BEV plug 2702. Automatic ejection control system 2712 can control the linear actuator assembly 2708 to eject EV plug 2702 from an electric vehicle and can enable; disable the charging station 2714.

While FIG. 27 illustrates a CCS2 automatic ejection system embodiment with an EV plug 2702 that uses a BEV CCS2 connector in accordance with the disclosure, those of skill in the art will recognize that the same principles, components, and connections can be used with other connectors, including a BEV plug that uses a Type 2 connector.

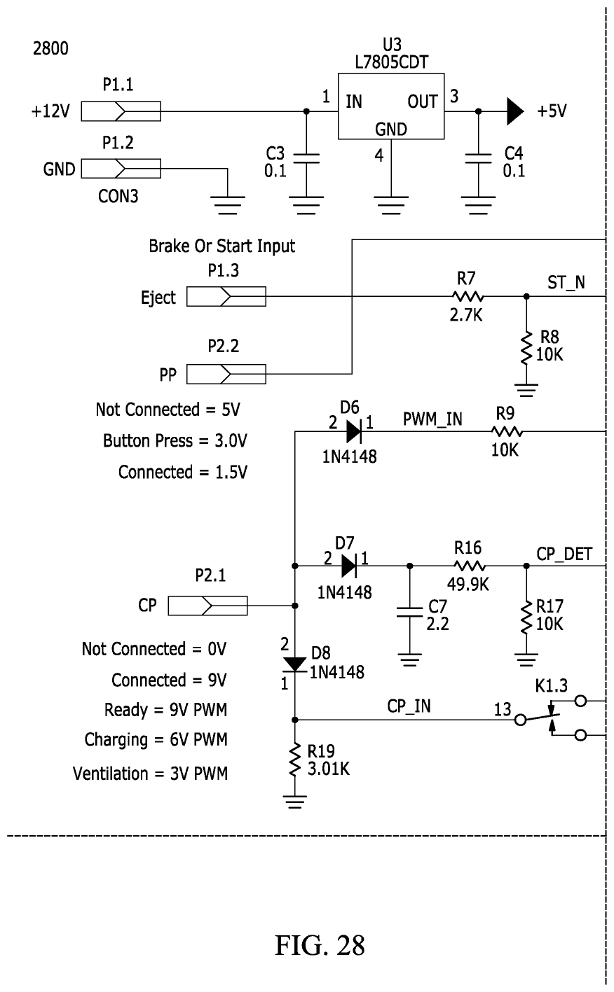

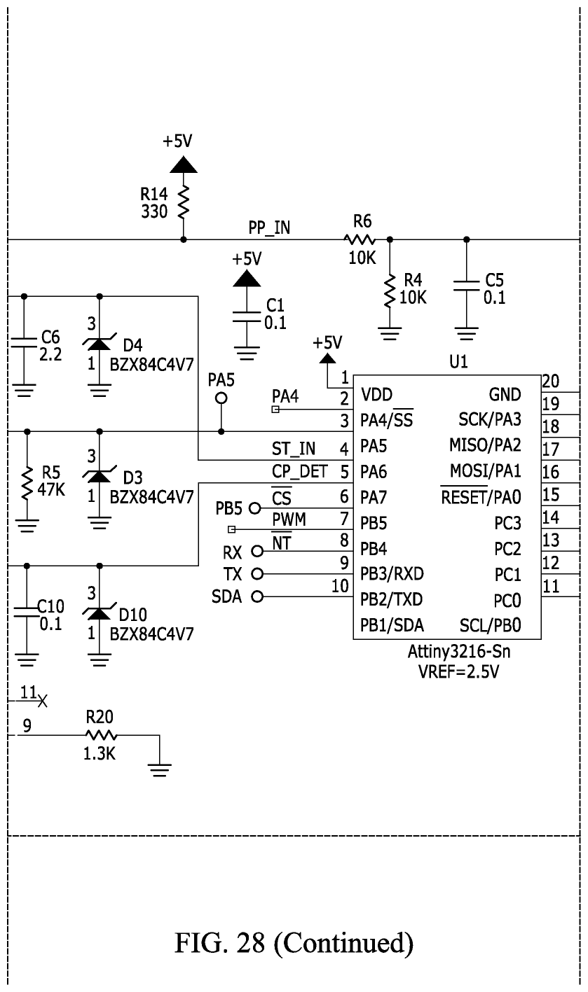

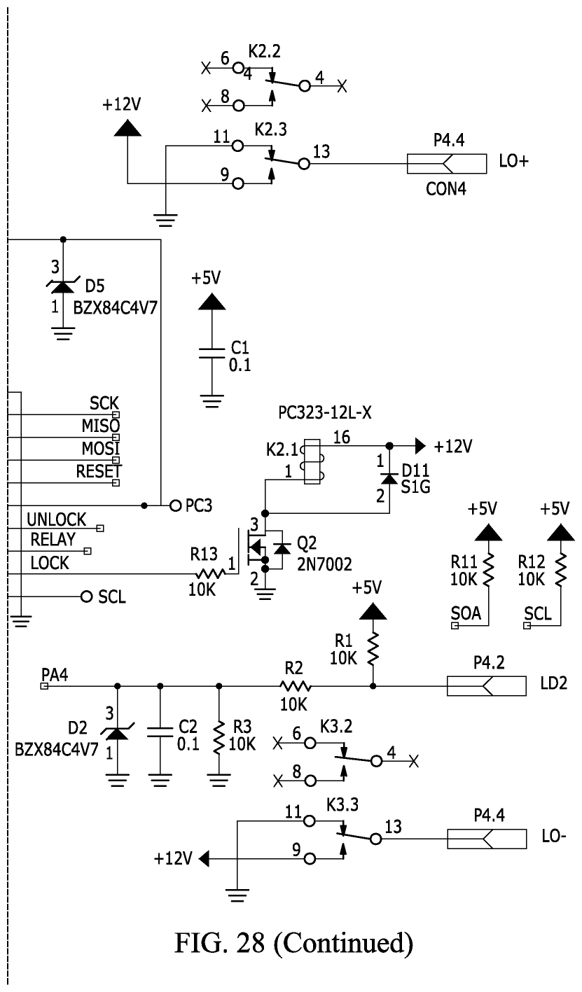

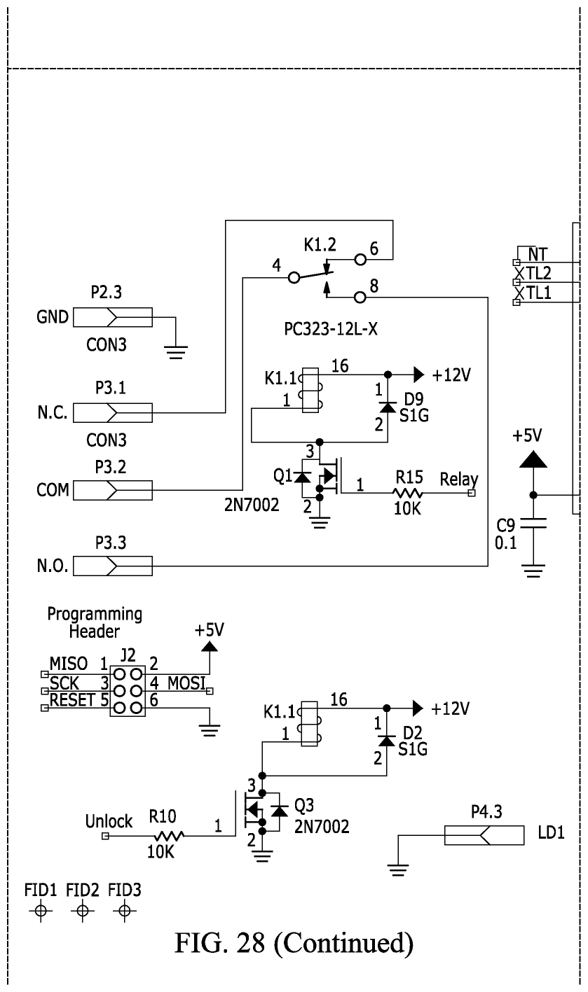

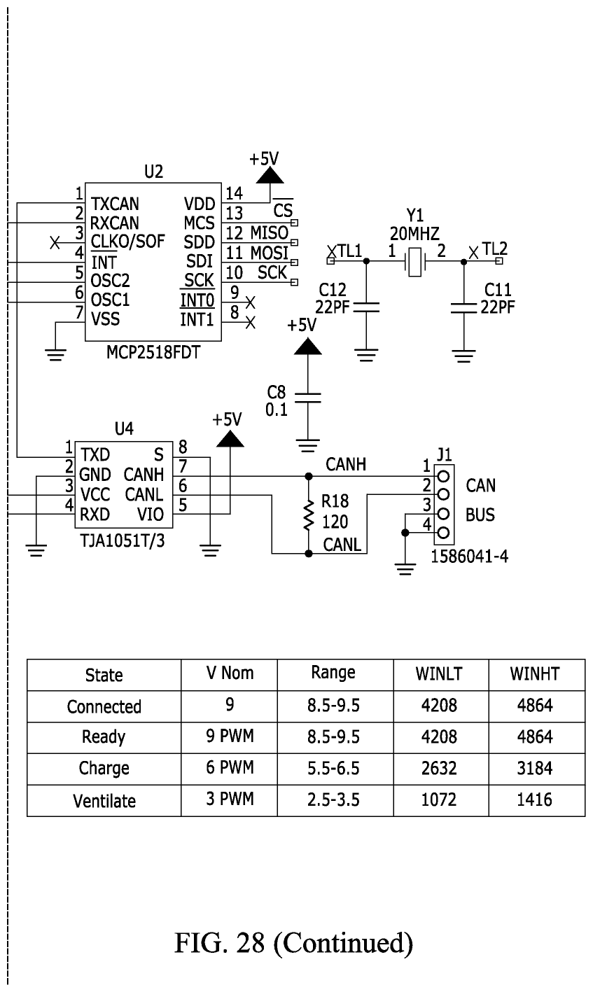

FIG. 28 illustrates an example of an electrical schematic 2800 for an automatic ejection system embodiment in accordance with the disclosure, such as for use in automatic ejection control system 2712 and others disclosed herein.

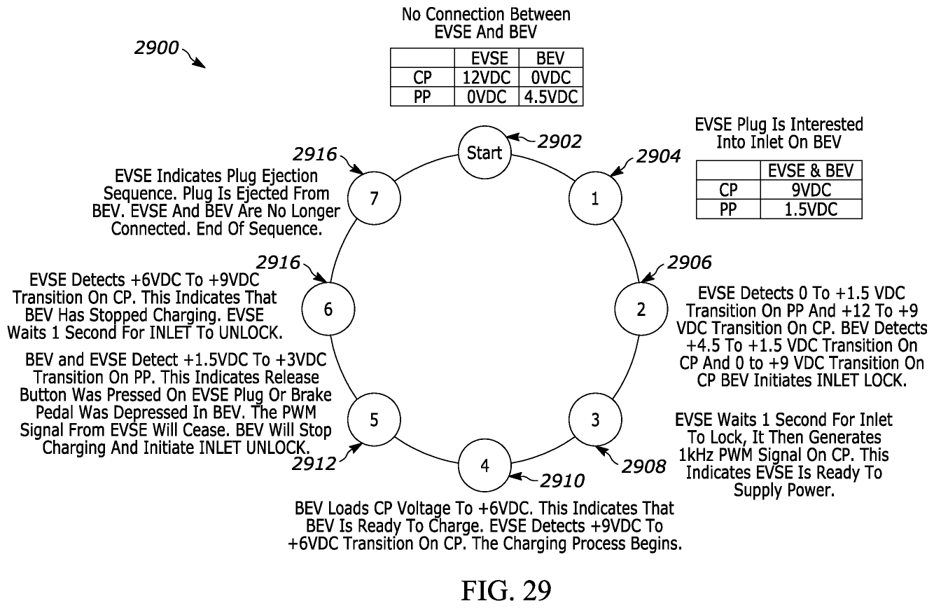

FIG. 29 illustrates an example of a state sequence 2900 for one implementation of an automatic ejection control system EVSE (the “system”) in accordance with disclosed embodiments.

At the start State 0 2902, ˜+5 direct current volts (VDC) are present on the Proximity Pilot (PP) connection, sourced by the EV. Proximity Pilot serves as a charge cable detection and current limitation, as is known to those of skill in the art, and can detect whether electric vehicle is connected to a charging system. The PP shows a voltage drop when a plug is connected. When disconnected, the PP connection on the system side is pulled down to 0VDC.

At State 0 2902, the system provides 12 VDC on the Communication Pilot (CP) connection, powered by the system. Communications Pilot is primarily a safety measure for the charging process. Without the Communication Pilot, no EV will start charging. As known to those of skill in the art, in ready state, the Communication Pilot is a 1 kHz signal with a ±12 VDC square wave generated by the EV charger. This is a PWM signal. The CP can be used to indicate that EV and EV charger are connected, to signal the maximum current the EV is allowed to draw, to signal that the EV wants to receive power, and when both EV and EV charger are capable, indicate that ISO15118 protocol should be used. When disconnected, the CP connection on the EV side is pulled down to 0VDC.

At State 1 2904, an automatic-eject plug as disclosed herein is inserted into the power inlet of an EV.

At State 2 2906, the system detects that PP transitions from 0VDC to +1.5 VDC, indicating the automatic-eject plug was inserted. The EV initiates the power inlet locking sequence.

At State 3 2908, the system detects that CP transitions to +9 VDC, indicating that the EV power inlet is locked on the automatic-eject plug. The EVSE begins generating 9V PWM. This indicates that the EVSE is ready to provide power to the EV.

At State 4 2910, the system detects that CP transitions to the PWM state. The EV loads CP to reduce the PWM to +6 VDC, indicating that the EV is charging.

At State 5 2912, the system detects that PP transitions to +3 VDC, indicating the release button on automatic-eject plug was depressed or brake pedal in EV was pressed. The EVSE stops charging and stops the PWM. The EV will stop charging and unload CP allowing it to change to the +9 VDC state. It will then unlock the power inlet.

At State 6 2915, the system detects that CP transitions to +9 VDC, indicating that the EV has stopped charging and the power inlet is unlocked. At this time the system is in the “connected, but not ready” state.

At State 7 2916, the system initiates a plug ejection sequence as described herein, whether by releasing a lock and allowing a spring-power collar to release the automatic-eject plug, by powering a linear actuator to eject the automatic-eject plug, by powering servo motor to eject the automatic-eject plug, or otherwise. The automatic-eject plug is ejected from the EV, the EV is no longer connected to the system, and the state sequence ends. Successful ejection may be verified at both EVSE and EV by CP and PP returning to “disconnected state” voltages.

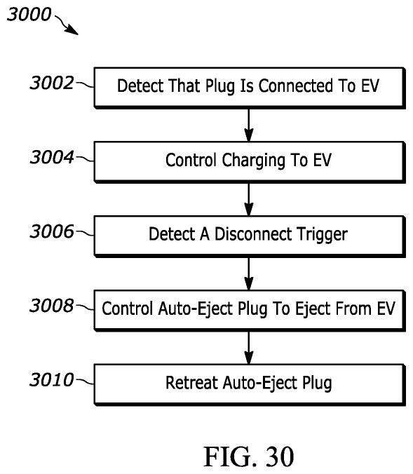

FIG. 30 depicts a flowchart of a process in accordance with disclosed embodiments that can be performed, for example, by an automatic ejection control system EVSE (the “system”) as disclosed herein.

At 3002, the system detects that an automatic-eject plug has been connected to an EV. The automatic-eject plug can be any charging plug with features described herein, including plugs using any EV connection type or configuration described herein.

At 3004, the system controls charging to the EV through the automatic-eject plug.

At 3006, the system detects a disconnect trigger. The disconnect trigger can be, for example, a signal indicating that charging has completed, a signal indicating that charging has been interrupted, a signal indicating that a brake pedal has been pressed on the EV, a remote-control disconnect signal, or any trigger that indicates that the automatic-eject plug should be ejected from the EV. In response to detecting the disconnect trigger, the system can also remove or cut off charging power to the automatic-eject plug.

At 3008, the system controls the automatic-eject plug to cause it to eject from the EV. This can be by activating an air actuated cylinder, activating a linear actuator, activating a motor, activating a solenoid, or otherwise forcing the automatic-eject plug to eject itself from the EV as disclosed herein. This can also include causing the automatic-eject plug to depress a release button, such as by activating an air actuated cylinder, activating a linear actuator, activating a motor, activating a solenoid, or otherwise as disclosed herein.

At 3010, in some embodiments, the system can retract the automatic-eject plug and any connected cables from the immediate proximity of the EV, and in some cases from the floor. This can be performed by activating an automatic winch, activating a spring-assisted retraction mechanism, activating a retraction boom, or otherwise.

In any of the examples described herein, any number of actuators or sensors described herein can be connected to detect the need to eject and operate the mechanical disconnect mechanism to eject a plug as described herein. Moreover, multiple ones of these various sensors and inputs can be concurrently connected so that if any of them are activated, the plug is ejected from the receptacle apparatus. This ensures that if any of several events or conditions occurs as described herein, including a detection that a charging process is complete, the plug is ejected to ensure a safe disconnection before the vehicle, trailer, or marine vessel moves. Systems and methods as disclosed herein not only are safer than existing systems but can be more convenient for an operator who can simply get into his vehicle and drive away without worrying about disconnection, since the disconnection will occur automatically.

Of course, those of skill in the art will recognize that, unless specifically indicated or required by the sequence of operations, certain steps in the processes described above may be omitted, performed concurrently or sequentially, or performed in a different order. Similarly, any of the features described above for different embodiments, or in the incorporated applications, can be combined with others for still further embodiments within the scope of the disclosure.

Those skilled in the art will recognize that, for simplicity and clarity, the full structure and operation of all systems or mechanisms suitable for use with the present disclosure is not being depicted or described herein. Instead, only so much of a delivery apparatus as is unique to the present disclosure or necessary for an understanding of the present disclosure is depicted and described. The remainder of the construction and operation of the embodiments above may confirm to any of the various current implementations and practices known in the art.

Although an exemplary embodiment of the present disclosure has been described in detail, those skilled in the art will understand that various changes, substitutions, variations, and improvements disclosed herein may be made without departing from the spirit and scope of the disclosure in its broadest form. Specific structures, dimensions, shapes, voltages, connections, commercial products, and other features described or illustrated herein are non-limiting unless specifically claimed. Those of skill in the art will recognize that the features and techniques disclosed herein can be combined in any number of ways within the scope of the disclosure, and can be used in combination with any type of removable electrical plug for electric vehicles.

None of the description in the present application should be read as implying that any particular element, step, or function is an essential element which must be included in the claim scope: the scope of patented subject matter is defined only by the allowed claims. Moreover, none of these claims are intended to invoke 35 USC § 112(f) unless the exact words “means for” are followed by a participle. The use of terms such as (but not limited to) “mechanism,” “module,” “device,” “unit,” “component,” “element,” “member,” “apparatus,” “machine,” “system,” “processor,” or “controller,” within a claim is understood and intended to refer to structures known to those skilled in the relevant art, as further modified or enhanced by the features of the claims themselves, and is not intended to invoke 35 U.S.C. § 112(f).

What is claimed is:

1. A method for controlling an automatic-ejection plug connected to an electric vehicle, comprising:
detecting a disconnect trigger by an automatic ejection control system, the disconnect trigger indicating that an automatic-eject plug should be ejected from an electric vehicle;
in response to detecting the disconnect trigger, controlling an ejection assembly connected to the automatic-eject plug to cause the automatic-eject plug to eject from the electric vehicle.

2. The method of claim 1, further comprising, before detecting the disconnect trigger:
detecting that the automatic-eject plug is connected to the electric vehicle; and
controlling charging to the electric vehicle through the automatic-eject plug.

3. The method of claim 1, wherein the automatic-eject plug has a connection that conforms to one of the Electric Vehicle Supply Equipment (EVSE), Combined Charging Standard/Type 1 (CCS1), Combined Charging Standard/Type 2 (CCS2), North American Charging Standard (NACS), International Electrotechnical Commission (IEC) 62196 Type 1, IEC Type 2, IEC Type 3, and TS-0023666 standard connections.

4. The method of claim 1, wherein controlling the ejection assembly to cause the automatic-eject plug to eject from the electric vehicle includes activating an air actuated cylinder.

5. The method of claim 1, wherein controlling the ejection assembly to cause the automatic-eject plug to eject from the electric vehicle includes activating a linear actuator.

6. The method of claim 1, wherein controlling the ejection assembly to cause the automatic-eject plug to cause the automatic-eject plug to eject from the electric vehicle includes activating a motor.

7. The method of claim 1, wherein controlling the ejection assembly to cause the automatic-eject plug to eject from the electric vehicle includes activating a solenoid.

8. The method of claim 1, wherein detecting a disconnect trigger includes detecting a signal indicating that charging has completed.

9. The method of claim 1, wherein detecting a disconnect trigger includes detecting a signal indicating that a brake pedal has been pressed on the electric vehicle.

10. The method of claim 1, wherein detecting a disconnect trigger includes detecting a remote-control disconnect signal.

11. The method of claim 1, further comprising retracting the automatic-eject plug from the immediate proximity of the electric vehicle.

12. An automatic ejection control system for an electric vehicle plug, the automatic ejection control system configured to:
detect a disconnect trigger, the disconnect trigger indicating that the electric vehicle plug should be ejected from an electric vehicle;
in response to detecting the disconnect trigger, cause the electric vehicle plug to eject from the electric vehicle,
wherein the automatic ejection assembly is removably attached to the electric vehicle plug.

13. The automatic ejection control system of claim 13, wherein the electric vehicle plug has a connection that conforms to one of the Electric Vehicle Supply Equipment (EVSE), Combined Charging Standard/Type 1 (CCS1), Combined Charging Standard/Type 2 (CCS2), North American Charging Standard (NACS), International Electrotechnical Commission (IEC) 62196 Type 1, IEC Type 2, IEC Type 3, and TS-0023666 standard connections.

14. The automatic ejection control system of claim 13, wherein causing the electric vehicle plug to eject from the electric vehicle includes at least one of activating an air actuated cylinder of the automatic ejection assembly, activating a linear actuator of the automatic ejection assembly, activating a motor of the automatic ejection assembly, or activating a solenoid of the automatic ejection assembly.

15. The automatic ejection control system of claim 13, wherein detecting a disconnect trigger includes at least one of detecting a signal indicating that charging has completed, detecting a signal indicating that a brake pedal has been pressed on the electric vehicle, or detecting a remote-control disconnect signal.

16. An automatic ejection assembly, comprising:
a mounting assembly for mounting the automatic ejection assembly to an electric vehicle plug; and
a first automatic ejection mechanism configured to cause the electric vehicle plug to eject from an electric vehicle.

17. The automatic ejection assembly of claim 17, wherein the electric vehicle plug includes a connection end that conforms to one of the Electric Vehicle Supply Equipment (EVSE), Combined Charging Standard/Type 1 (CCS1), Combined Charging Standard/Type 2 (CCS2), North American Charging Standard (NACS), International Electrotechnical Commission (IEC) 62196 Type 1, IEC Type 2, IEC Type 3, and TS-0023666 standard connections.

18. The automatic ejection assembly of claim 17, wherein the first automatic-ejection mechanism includes a spring-loaded collar.

19. The automatic ejection assembly of claim 17, further comprising a second automatic-ejection mechanism configured to activate a release mechanism of the electric vehicle plug, wherein the second automatic-ejection mechanism includes at least one of an air actuated cylinder, a linear actuator, a motor, or a solenoid.
